(19) United States
(12) Patent Application Publication
(10) Pub. No.: US 2019/0129063 A1
(43) Pub. Date: May 2, 2019

(54) METHOD FOR WELLBORE SURVEY INSTRUMENT FAULT DETECTION

(71) Applicant: Scientific Drilling International, Inc., Houston, TX (US)

(72) Inventors: Mohamed YOUSSEF, Paso Robles, CA (US); Brian GLEASON, Atascadero, CA (US)

(21) Appl. No.: 16/093,712

(22) PCT Filed: Apr. 28, 2017
(86) PCT No.: PCT/US17/30249

§ 371 Date: Oct. 15, 2018

Related U.S. Application Data
(60) Provisional application No. 62/330,131, filed on Apr. 30, 2016.

(51) Int. Cl. G01V 13/00

(52) U.S. Cl. CPC G01V 13/00

(57) ABSTRACT

A method for determining sensor failure may include measuring a plurality of data points of a modeling parameter with a sensor, and generating a model for the measured data points. The method may also include estimating anticipated data points for each of the measured data points, and determining a residual between a measured data point of the plurality of data points and a corresponding anticipated data point. In addition, the method may include determining if the residual is above a preselected sensor fault threshold, and, if the residual is above the preselected sensor fault threshold, measuring a second plurality of data points of the modeling parameter with the sensor.

### CROSS-REFERENCE TO RELATED APPLICATIONS

This application claims priority from U.S. provisional application No. 62/330,131, filed Apr. 30, 2016.

### TECHNICAL FIELD/FIELD OF THE DISCLOSURE

The present disclosure relates to downhole measurement tools and specifically to fault detection in downhole measurement tools.

### BACKGROUND OF THE DISCLOSURE

Knowledge of wellbore position is useful for the development of subsurface oil & gas deposits. Accurate knowledge of the position of a wellbore at a measured depth, including inclination and azimuth of the wellbore, may be used to determine the geometric target location of, for example, a hydrocarbon bearing formation of interest. Additionally, directional borehole drilling typically relies on one or more directional devices such as bent subs and rotary steering systems to direct the course of the wellbore. The angle between the reference direction of the directional device and an external reference direction is referred to as the toolface angle, and may determine the direction of deviation of the wellbore as the wellbore is drilled. During directional drilling, the placement of the borehole is typically compared with the desired path, and a toolface angle and other drilling parameters are selected to advance the borehole and correct the wellbore towards the desired path. Measurement of toolface thus may be a component for borehole steering and placement.

The measurement of inclination and azimuth of the wellbore may be used in surveying operations. Inclination is the angle between the longitudinal axis of a wellbore or a drill string or other downhole tool positioned in a wellbore and the gravity vector, and azimuth is the angle between a horizontal projection of the longitudinal axis and north, whether measured by a magnetometer (magnetic north) or by a gyro (true north).

One method of determining the orientation and position of a downhole tool with respect to the Earth spin vector is to take a gyro survey, referred to herein as a gyrocompass, to determine a gyro toolface, inclination, and azimuth. Gyrocompassing utilizes one or more gyroscopic sensors, referred to herein as “gyros” to detect the Earth's rotation and determine the direction to true north from the downhole tool, the reference direction for a gyro toolface and azimuth. However, at high inclinations, i.e. where the downhole tool is nearly horizontal with respect to gravity, a single-axis gyro substantially orthogonal to the downhole tool may be unable to determine true north to a desired accuracy. Additionally, errors in gyro readings caused by, for example and without limitation, bias errors or mass unbalance, may induce error in the determination of true north.

The determination of orientation, position, inclination, and azimuth of the downhole tool may include determining a gravity toolface or magnetic toolface by using one or more accelerometers or magnetometers, respectively. Accelerometers may be used to detect the local gravity field, typically dominated by the Earth's gravity, to determine the direction to the center of the Earth. This direction may be used as the reference direction for a gravity toolface. Magnetometers may be used to detect the local magnetic field, typically dominated by the Earth's magnetic field, to determine the direction to magnetic north. Magnetic north may be used as the reference direction for a magnetic toolface. However, errors in the sensor readings, such as offset or drift, may induce error in the determination of toolface.

### SUMMARY

A method for determining sensor failure for a survey tool in a wellbore is disclosed. The method includes measuring a plurality of data points of a modeling parameter with a sensor, and generating a model for the measured data points. The method also includes estimating anticipated data points for each of the measured data points, and determining a residual between a measured data point of the plurality of data points and a corresponding anticipated data point. In addition, the method includes determining if the residual is above a preselected sensor fault threshold, and, if the residual is above the preselected sensor fault threshold, measuring a second plurality of data points of the modeling parameter with the sensor.

A method for determining sensor failure for a survey tool in a wellbore is disclosed. The method includes measuring a plurality of data points of a modeling parameter with a sensor and generating a model for the measured data points. The method also includes estimating anticipated data points for each of the measured data points and determining a residual between a measured data point of the plurality of data points and a corresponding anticipated data point. In addition, the method includes determining if the residual is above a preselected sensor fault threshold and, if the residual is above the preselected sensor fault threshold, generating a second model for the measured data points.

A method for determining sensor failure for a survey tool in a wellbore is disclosed. The method includes measuring a plurality of data points of a modeling parameter with a sensor and generating a model for the measured data points. The method also includes estimating anticipated data points for each of the measured data points and determining a residual between a measured data point of the plurality of data points and a corresponding anticipated data point. The method further includes determining if the residual is above a preselected sensor fault threshold and, if the residual is above the preselected sensor fault threshold, removing the sensor from the wellbore.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a survey tool in a wellbore consistent with at least one embodiment of the present disclosure.

FIG. 2 depicts a flow chart of a fault detection operation consistent with at least one embodiment of the present disclosure.

FIG. 3 depicts a flow chart of a model selection operation consistent with at least one embodiment of the present disclosure.

FIG. 4 depicts data of a fault detection operation consistent with at least one embodiment of the present disclosure.

FIG. 5 depicts data of a fault detection operation consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

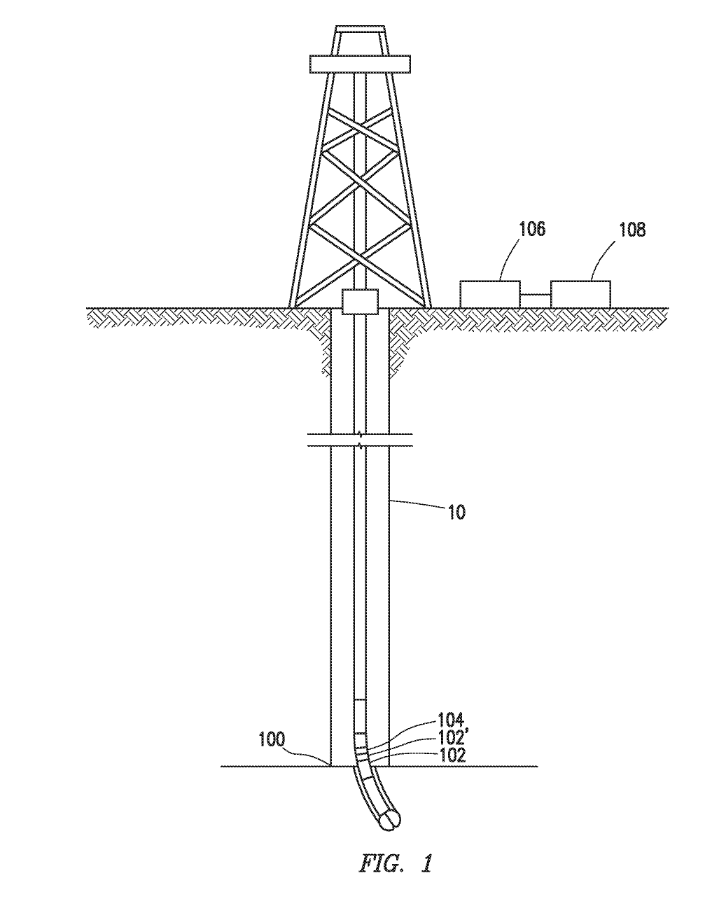

FIG. 1 depicts a survey tool 100 positioned in wellbore 10. Survey tool 100 may include one or more sensors 102, including, for example and without limitation, one or more gyros, accelerometers, or magnetometers. In some embodiments, sensors 102 may be single or multiaxial, including triaxial gyros, accelerometers, or magnetometers. Sensors 102 of survey tool 100 may be used to measure parameters of wellbore 10 at the location of survey tool 100. Parameters of wellbore 10 may include, for example and without limitation, an Earth rotation vector, local gravity field, and local magnetic field at survey tool 100. Survey tool 100 may be moved through wellbore 10, and measurements may be taken by sensors 102 of survey tool 100. Each such measurement is referred to herein as a “survey”.

In some embodiments, survey tool 100 may include downhole controller 104, which may utilize measurements from sensors 102 of survey tool 100 to generate a model of or determine modeling parameters of a sensor, instrument, tool and/or wellbore 10. A modeling parameter may be a shaping parameter, a shifting parameter, a scaling parameter, or a combination thereof. In some embodiments, survey tool 100 may include a transmitter for transmitting the measurements to surface receiver 106 which may be in communication with surface controller 108 to generate the model of wellbore 10 from the measurements from sensors 102.

In some embodiments, sensors 102 may be used to determine the value of a modeling parameter. Because measurements from sensors 102 may include error such as random noise or interference or may be affected by a fault in sensors 102, in some embodiments, a data driven model, referred to herein as a model, may be generated to determine the value of the modeling parameter from the measured data from sensors 102. In some embodiments, the model may be a single sensor model or a multiple sensor model. In some embodiments, the modeling parameter may be a parameter directly measured by one or more of sensors 102 or may be a parameter derived from measurements of one or more of sensors 102.

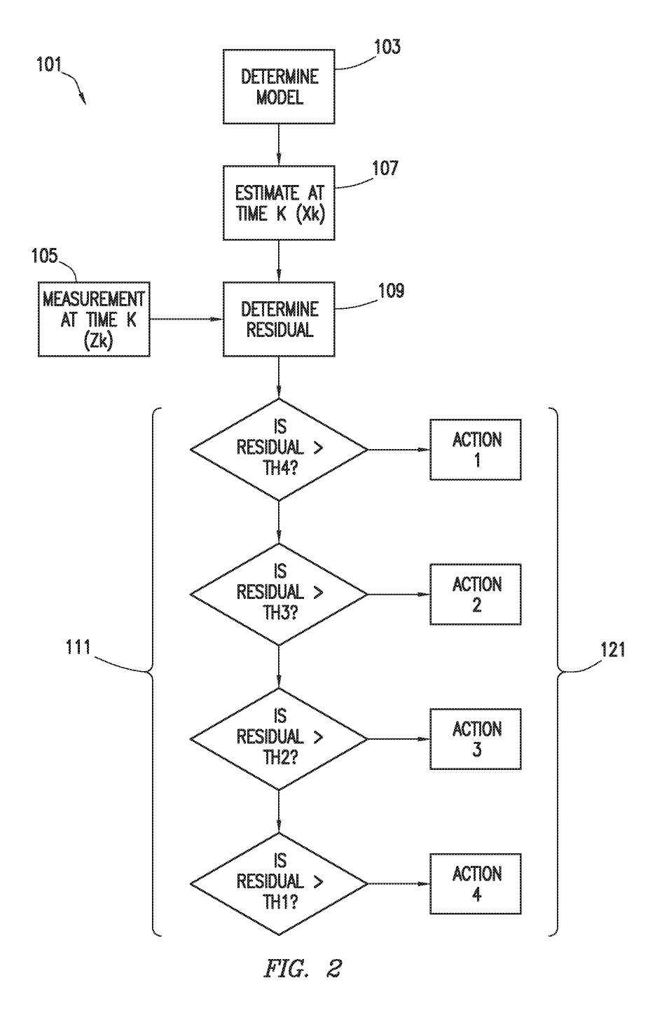

In some embodiments, measurements from sensors 102 may be analyzed to determine whether a sensor fault has occurred. A sensor fault, as used herein, refers to an instance in which data from measurements of sensors 102 do not conform to estimated data from a model. For example and without limitation, sensor fault may include a loss of calibration of a sensor, breakage or failure of the sensor, or other incapacitation or unacceptable error in the measurements of one or more of sensors 102. As an example and without limitation, where sensors 102 include a gyro, sensor fault may include mass unbalance shifts of the gyro. In some such embodiments, measurements from sensors 102 may be compared to estimated measurements from the model. In some embodiments, as depicted in FIG. 2, sensor fault detection operation 101 may include determine model 103.

In some embodiments, measurements from sensors 102 may be used to generate the data driven model. In some embodiments, the model to be utilized may be selected by machine learning. As understood in the art, the model may describe the relationship between a response (i.e. output) variable, and one or more predictor (i.e. input) variables. Statistics and machine learning may, for example and without limitation, allow the measurements from sensors 102 to be fit into one or more of a fit linear, generalized linear, or nonlinear regression models, including stepwise models, Gaussian process regression models, and mixed-effects models. Once a model is generated, estimated data may be predicted or simulated, and may be used to assess the model fit. Residuals are defined herein as the difference between actual measured data points and estimated or anticipated data points.

As previously discussed, in some embodiments, as depicted in FIG. 2, at each time step, each measurement (105) may be compared to the estimate (107) to determine the difference therebetween referred to herein as residuals (109). In some embodiments, the residuals may be utilized to determine the status of the sensor taking the measurement. In some embodiments, for example and without limitation, the residuals may be compared with one or more preselected sensor fault threshold values (111) may be preselected to determine if sensor fault has occurred. In some embodiments, sensor fault threshold values (111) may be determined utilizing prior data.

In some embodiments, multiple sensor fault thresholds, depicted as TH1-TH4 in FIG. 2, may be preselected and may be used to indicate different actions 121 to be taken to test for sensor fault. For example and without limitation, in some embodiments, actions 121 may include running another analysis on the measured data (105). For example, in some embodiments, the model may be applied to measurement data to estimate (107) a new set of data points to compare with the measured data (105). For example, in some embodiments, the estimated data (107) may be determined in a time-reversed method. In some embodiments, sensors 102 may be used to measure additional data (105) at the same location in wellbore 10. In some such embodiments, sensors 102 may be repositioned or reconfigured to measure additional data. For example and without limitation, where sensors 102 include one or more gimballed sensors, the gimballed sensors may be repositioned to take additional measurements or may be repositioned such that a different sensor of a multiple sensor package is utilized.

In some embodiments, actions 121 may include replacing the model generated at determine model 103 with an alternative model and the analysis repeated utilizing the new model.

In some embodiments, survey tool 100 may include one or more backup sensors 102′. In some such embodiments, actions 121 may include taking an additional survey at the same location in wellbore 10 utilizing backup sensors 102′. In some embodiments, downhole controller 104 or surface controller 108 may indicate that survey tool 100 should be withdrawn from wellbore 10, for example and without limitation, for repair or replacement of sensors 102. In some such embodiments, sensors 102 may be replaced with backup sensors 102′ after sensors 102 are withdrawn from wellbore 10.

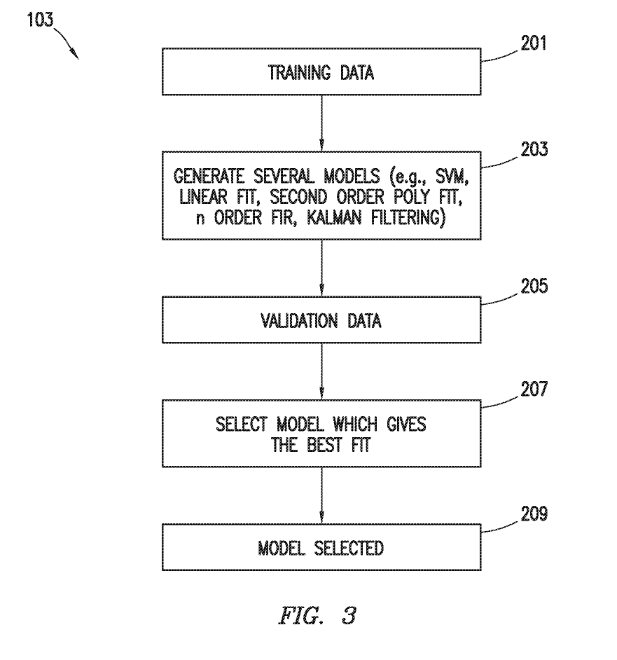

In some embodiments, determine model 103 as depicted in FIG. 3 may be undertaken before the analysis of the measurement data to determine sensor fault in order to determine the model to be used to analyze the measurement data. In some embodiments, a set of training data 201 may be selected. In some embodiments, training data 201 may be a subset of a set of measurements from sensors 102 to be analyzed. For example, in some embodiments in which historical data is being analyzed, a subset of measurements, such as 70% to 80% of the data measurements of the historical data, may be utilized as training data 201. In some embodiments in which data is collected concurrently with determine model 103, the first 7 or 8 of the last 10 measured data points may be utilized as training data 201. Training data 201 may be used as described herein below to generate one or more models 203. In some embodiments, the rest of the set of measurements from sensors 102 may be utilized as validation data 205 to determine the fitness of each model. In some embodiments, each model may be “scored” based on its determined fitness. Validation data 205 may be compared with extrapolated data from the models generated at 203, and the model having the best score may be selected 207. The selected model 209 may be utilized as described herein below.

In some embodiments, the model generated may be selected from one or more potential models. For example and without limitation, in some embodiments, the models may include neural networks, regression trees, or any computerized learning model. In some embodiments, support vector machine (SVM) may be a potential model. In some embodiments, linear SVM or non-Linear SVM may be utilized.

In a linear SVM regression, which is also known as “L1 loss implements linear epsilon-insensitive SVM (E-SVM) regression,” the set of training data may include input variables and output values. For example, given training data where xₙ is a multivariate set of N observations with observed response values yₙ, the SVM regression may determine the regression parameters β and bias b of linear function ƒ(x)=β^{T} x+b. The linear SVM may be used to generate a function ƒ(x) such that at each time n, yₙ deviates from each training point x by a residual value no greater than threshold error ε for each training point x while remaining substantially flat or linear. In some embodiments, ƒ(x) may be determined such that it has a minimal norm value (β^{T}β). This evaluation may, for example, constitute a convex optimization problem to minimize cost function J(β)=½β^{T} β, subject to all residuals having a value less than ε; or, in equation form: ∀n: |yₙ−(β^{T} xₙ+b)|≤ε.

In some embodiments, because it is possible that no such function f(x) exists to satisfy these constraints for all data points, slack variables ξₙ and ξₙ* may be introduced for each point. The objective formula for the linear SVM regression may thus be given by the primal formula:

$$J ( β ) = \frac{1}{2} {β}^{T} β + C {\sum }_{n = 1}^{N} ( {ξ}_{n} + {ξ}_{n}^{*} )$$

subject to:

∀n:yₙ−(β^{T}xₙ+b)≤ε+ξₙ

∀n:(β^{T}xₙ+b)−yₙ≤ε+ξₙ*

∀n:ξₙ*≥0

∀n:ξₙ≥0

where the constant C is the box constraint, a positive numeric value that controls the penalty imposed on observations that lie outside the epsilon margin (c) and may reduce the possibility of overfitting (regularization).

As understood in the art with the benefit of this disclosure, in mathematical optimization theory, duality means that optimization problems may be viewed from either of two perspectives, the primal problem or the dual problem (the duality principle). The solution to the dual problem may, in some embodiments, provide a lower bound to the solution of the primal (minimization) problem. In general the optimal values of the primal and dual problems need not be equal as understood in the art. The difference between the primal minimization and the dual minimization is called the duality gap. The dual problem may be, for example and without limitation, the Lagrangian dual problem, Wolfe dual problem, or Fenchel dual problem. In some embodiments in which a Lagrangian dual formula is utilized, a Lagrangian function may be constructed from the primal function by introducing nonnegative multipliers αₙ and αₙ* for each observation xₙ, giving the dual formula:

$$L ( α ) = \frac{1}{2} {\sum }_{i = 1}^{N} {\sum }_{j = 1}^{N} ( {α}_{j} - {α}_{j}^{*} ) {x}_{i}^{T} {x}_{j} + ɛ {\sum }_{i = 1}^{N} ( {α}_{j} + {α}_{j}^{*} ) + {\sum }_{i = 1}^{N} {y}_{i} ( {α}_{j} - {α}_{j}^{*} )$$

subject to:

$${\sum }_{i = 1}^{N} {y}_{i} ( {α}_{n} - {α}_{n}^{*} ) = 0$$

$$∀ n : 0 \leq {α}_{n} \leq C$$

$$∀ n : 0 \leq {α}_{n}^{*} \leq C$$

The β parameter may be completely described as a linear combination of the training observations using the equation β=Σₙ₌₁^{N}(αⱼ−αᵢ*)xₙ. The function ƒ(x) is then equal to:

$$f ( x ) = {\sum }_{n = 1}^{N} ( {α}_{n} - {α}_{n}^{*} ) ( {x}_{n}^{T} {x}_{n} ) + b$$

In some embodiments, Karush-Kuhn-Tucker (KKT) complementarity conditions may be used to obtain optimal solution. For linear SVM regression, these conditions may be:

∀n:αₙ(ε+ξₙ−yₙ+β^{T}xₙ+b)=0

∀n:αₙ*(ε+ξₙ*+yₙ−β^{T}xₙ+b)=0

∀n:ξₙ*(C−αₙ*)=0

∀n:ξₙ(C−αₙ*)=0

In some cases, the measurement data may not be adequately described using a linear regression model. In such a case, the Lagrange dual formulation may allow the previously-described technique to be extended to nonlinear functions by incorporating nonlinear kernel function such as Gaussian and inhomogeneous polynomial.

In some embodiments, the minimization problem may be expressed in standard quadratic programming form and solved using common quadratic programming techniques. However, it can be computationally expensive to use quadratic programming algorithms. In some embodiments, a decomposition method may be utilized. In some such embodiments, decomposition methods may separate all measurements into two sets: the working set and the remaining set. A decomposition method may modify only the elements in the working set in each iteration. In some embodiments, Sequential minimal optimization (SMO) may be utilized to solve the SVM problems. SMO performs a series of two-point optimizations. In each iteration, a working set of two points may be chosen based on a selection rule that uses second-order information. The Lagrange multipliers for the working set may then be solved analytically. See, e.g., Andrew Ng, Machine Learning lecture notes and presentations by Andrew Ng, Coursera (last visited Apr. 28, 2017), https://www.coursera.org/learn/machine-learning; Yaser S. Abu-Mostafa et al., Learning From Data (2012); and Christopher Bishop, Pattern Recognition and Machine Learning, (2007); each of which is hereby incorporated by reference in its entirety.

In some embodiments, a recursive Bayesian filter may be a potential model to be selected at determine model 103. The recursive Bayesian filter may recursively estimate the actual value of the modeling parameter utilizing the incoming measurements over time and a mathematical process model. The recursive Bayesian filter may account for statistical noise, error in the sensor, and other inaccuracies in the measurements. The recursive Bayesian filter may include, for example and without limitation, a Kalman filter, extended Kalman filter, unscented Kalman filter, or Particle filter. For the purposes of this disclosure, a Kalman filter will be described; however, one having ordinary skill in the art with the benefit of this disclosure will understand that any other model may be utilized without deviating from the scope of this disclosure.

In some embodiments, a Kalman filter may operate in a two-step process: a prediction step and a correction step. In the prediction step, the Kalman filter may estimate values of the current state variables along with the uncertainty of the estimate. State variables, as used herein, may refer to modeling parameters being measured or the deviation of the measurement of the modeling parameter from the estimated value. In some embodiments, state variables may include, for example and without limitation, accelerometer sensor output, magnetometer output, or gyro sensor output. The estimated value of the current state variable and uncertainty of the estimate may be based on one or more of an initial estimate to value or uncertainty or prior measurements and error calculations. Once the next measurement is taken, the estimates may be updated using a weighted average, with more weight being given to estimates with lower uncertainty. In some embodiments, the Kalman filter may be run in real time between measurements or may be run after a series of measurements have been taken.

As an example and without being bound to theory, a simple discrete linear Kalman filter utilizes a linear state model, given by:

xₖ₊₁=A*xₖ+wₖ

zₖ=H*xₖ+vₖ

### Where:

xₖ:=estimated state variable at time k, (n×1) vector
zₖ:=is the measurement/observation at time k, (m×1) vector
A:=state transition matrix, (n×n) matrix
H:=is the observation model which maps the true state space into the observed space, (m×n) matrix
wₖ:=is the process noise, (n×1) vector
vₖ:=is the measurement/observation noise, (n×1) vector

In the prediction step, an estimate, xₚ, of the state variable and the error covariance, Pₚ, may be predicted. The estimates xₚ and Pₚ may be determined by:

xₚ=A*x

Pₚ=A*P*A^{T}+Q

where Q is the covariance matrix of wₖ.

In the correction step, an updated estimate of the state variable x and error covariance P may be estimated, determined by:

x=xₚ+K*(z−H*xₚ)

P=Pₚ−K*H*Pₚ

where K is the Kalman gain, given by:

K=Pₚ*H^{T}*(H*Pₚ*H^{T}+R)⁻¹

As previously discussed, in some embodiments, at each time step, each measurement zₖ may be compared to the estimate xₖ to determine the residual for whichever model is generated and the residuals may be compared to the preselected sensor fault threshold or thresholds.

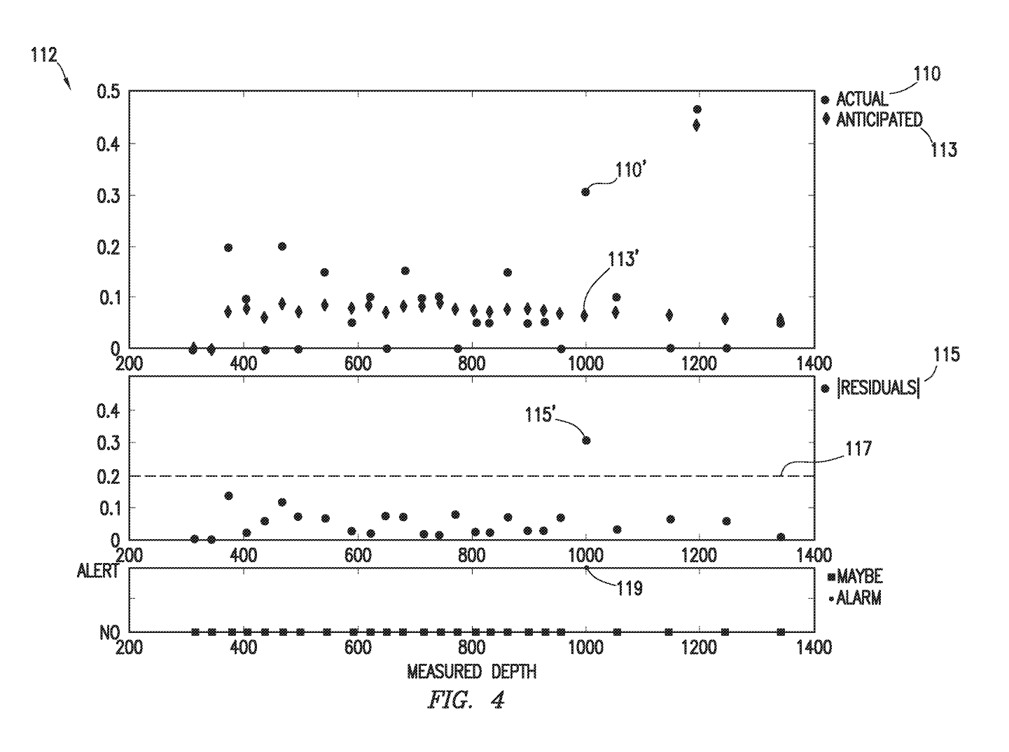

In some embodiments, the sensor fault threshold value or values may be selected based on the type of sensor or the type of survey tool 100. In some embodiments, the sensor fault threshold value may be selected based on whether wellbore 10 is drilled onshore or offshore. For example, as depicted in FIG. 4, actual measured data points 110 may be compared with estimated or anticipated data points 113 from survey data 112. Residuals 115 may be determined for each pair of actual measured data points 110 and anticipated data points 113. In some embodiments, residuals may be expressed as the absolute value of the difference between corresponding actual measured data points 110 and anticipated data points 113. In some embodiments, each residual 115 may be compared to preselected sensor fault threshold 117 to identify measurements for which residual 115 is above the preselected sensor fault threshold 117. For example, in FIG. 4, where residual 115′ calculated from actual measured data point 110′ and anticipated data point 113′ is determined to be above preselected sensor fault threshold 117, alert 119 may be indicated for the associated measurement. Residual 115′ being above preselected sensor fault threshold 117 may, for example and without limitation, indicate a sensor fault.

In some embodiments, preselected sensor fault threshold 117 may be expressed as a mean square error, an absolute value, or as a percent offset between actual measured data points 110 and anticipated data points 113.

In some embodiments, when alert 119 is indicated, downhole controller 104 or surface controller 108 may cause one or more actions to be undertaken. For example and without limitation, in some embodiments, the action may include running another analysis on the data from the survey. For example, in some embodiments, the Kalman filter or other model may be run again on the measurements from the survey in a time-reversed method and reexamining the residuals against the same or a different preselected sensor fault threshold. In some embodiments, the measurements of the survey may be retaken at the same location in wellbore 10. In some embodiments, the data analysis of the survey may be taken utilizing different underlying mathematical models.

Delta Earth Rate Horizontal (ERH)—An example of mathematical model is based on Delta ERH. Mass unbalance is a characteristic of a gyro sensor that causes a drift on the output of the gyro sensor in the presence of gravity. Monitoring the variation between the measured horizontal earth rotation rate and the theoretical horizontal earth rotation rate at a given location provides a method to inspect the validity of gyro sensor measurements. The difference between the measured horizontal earth rotation rate and the theoretical horizontal earth rotation rate is referred to herein as delta earth rate horizontal or Delta ERH.

The Earth's rotation rate may be separated into horizontal and vector component vectors. The horizontal component (Earth Rate Horizontal or ERH) is perpendicular to the gravity vector, and points north. The theoretical magnitudes of the ERH vector is a function of the latitude (λ) at the given location. ERH may be computed by:

ERH=15.041*cos(λ)

A gyro sensor that can be rotated in a gimbal frame through quadrature position may measure the ERH component. In some embodiments, the ERH component may be determined by fitting a sinusoidal function. In some such embodiments, for example, four data points {G₁, G₂, G₃, and G₄} at measured at different angles may be used to obtain the fit. The amplitude (Gₒ) of the gyroscope out can be determined from the collected data according to:

$${G}_{o} = \frac{1}{2} \sqrt[2]{{( {G}_{1} - {G}_{3} )}^{2} + {( {G}_{2} - {G}_{4} )}^{2}}$$

In other embodiments, rather than using four data points to fit the ERH component, a sine wave fit for ERH may be obtained by measuring ERH at two or more rotational orientations in the gimbal frame.

In this disclosure, the variation in the residual may be monitored to validate the gyro measurements and provide alerts based on the degree of the disagreement between the processed gyro measurements and the theoretical ERH. Based on Kalman filter equation described herein, the Kalman filter may be initialized by:

{x=delta ERH,A=1,H=1,Q=0.001,R=0.1, and P=0.1}

In some embodiments, survey tool 100 may estimate or measure mass unbalance terms during surveying operation as described in U.S. patent application Ser. No. 14/946,394, filed Nov. 19, 2015, the entirety of which is hereby incorporated by reference. As with ERH, predicted values for mass unbalance terms may be compared against the measured mass unbalance terms, providing a means for detecting wellbore survey instrument faults.

MWD survey results may be measured relative to the Earth's magnetic field and uncertainty in this reference may lead to survey errors. The magnitude and direction of the Earth's magnetic field may be characterized by the total field strength, declination angle and dip angle. Total field strength, declination angle and dip angle may be obtained from a mathematical model, such as the IGRF (International Geomagnetic Reference Field) or (BGS Global Geomagnetic Model) BGGM models.

True dip is the angle a plane makes with a horizontal plane, the angle being measured in a direction perpendicular to the strike of the plane. Apparent dip is the angle measured in any direction other than perpendicular to the strike of the plane. Given the apparent dip and the strike, or two apparent dips, the true dip may be computed.

In certain embodiments of the present disclosure, the variation between the dip angle obtained from the mathematical model and the measured dip angles may be monitored to validate the magnetometer measurement. In such embodiments, a fault might be detected in the magnetometer sensor due to nearby interference source.

In some embodiments, survey tool 100 may include one or more backup sensors 102′. In some such embodiments, downhole controller 104 or surface controller 108 may, in response to alert 119, cause an additional survey to be taken at the same location in wellbore 10 utilizing backup sensors 102′. In some embodiments, downhole controller 104 or surface controller 108 may indicate that survey tool 100 should be withdrawn from wellbore 10, for example and without limitation, for repair or replacement of sensors 102.

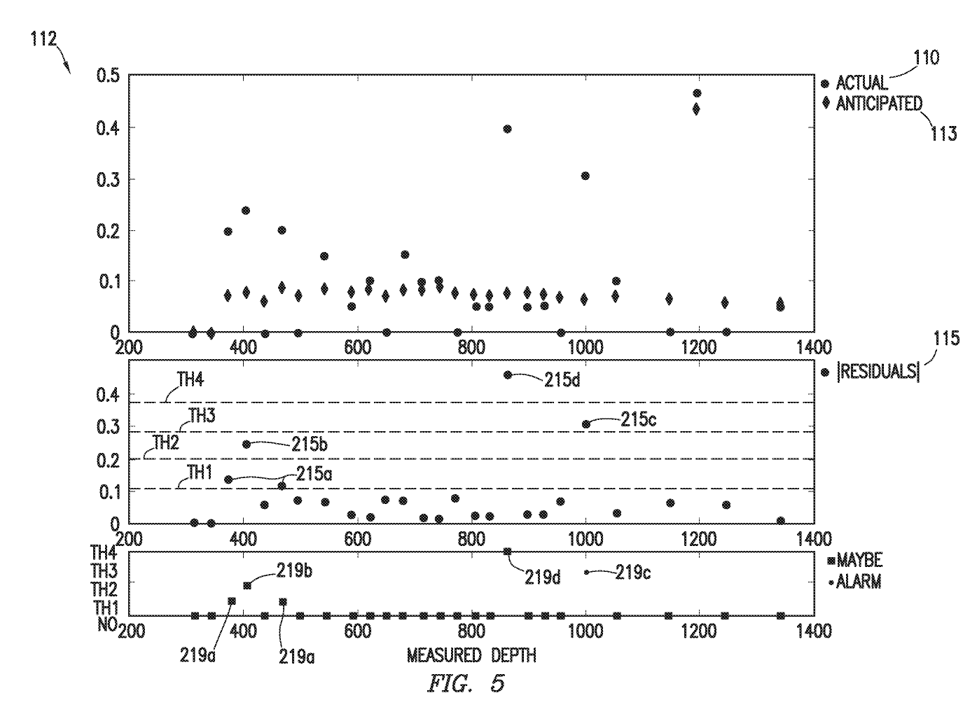

In some embodiments, multiple preselected sensor fault thresholds may be utilized. For example, as depicted in FIG. 5, alerts 219a-d may be triggered by residuals 215a-d which are above preselected sensor fault thresholds TH1, TH2, TH3, and TH4 respectively. In some such embodiments, each preselected sensor fault threshold may trigger a different response of downhole controller 104 or surface controller 108 as previously discussed.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A method for determining sensor failure for a survey tool in a wellbore comprising:
measuring a plurality of data points of a modeling parameter with a sensor;
generating a model for the measured data points;
estimating anticipated data points for each of the measured data points;
determining a residual between a measured data point of the plurality of data points and a corresponding anticipated data point;
determining if the residual is above a preselected sensor fault threshold; and
if the residual is above the preselected sensor fault threshold, measuring a second plurality of data points of the modeling parameter with the sensor.

2. The method of claim 1, wherein the model is generated utilizing a machine learning operation.

3. The method of claim 2, wherein the model is a linear or non-linear SVM regression, or a recursive Bayesian filter.

4. The method of claim 2, further comprising repositioning or reconfiguring the sensor before measuring the second plurality of data points.

5. The method of claim 1, further comprising:
determining if the residual is above a second preselected sensor fault threshold; and
if the residual is above the second preselected sensor fault threshold, generating a second model for the measured data points.

6. The method of claim 1, further comprising:
determining a second residual between a second measured data point of the second plurality of data points and a corresponding anticipated data point; and
determining if the second residual is above the preselected sensor fault threshold.

7. The method of claim 1, further comprising:
determining if the residual is above a second preselected sensor fault threshold; and
if the residual is above the second preselected sensor fault threshold:
measuring a third plurality of data points of the modeling parameter with a backup sensor;
determining a second residual between a second measured data point of the second plurality of data points and a corresponding anticipated data point; and
determining if the second residual is above the preselected sensor fault threshold.

8. The method of claim 1, further comprising:
determining if the residual is above a second preselected sensor fault threshold; and
if the residual is above the second preselected sensor fault threshold:
removing the sensor from the wellbore.

9. A method for determining sensor failure for a survey tool in a wellbore comprising:
measuring a plurality of data points of a modeling parameter with a sensor;
generating a model for the measured data points;
estimating anticipated data points for each of the measured data points;
determining a residual between a measured data point of the plurality of data points and a corresponding anticipated data point;
determining if the residual is above a preselected sensor fault threshold; and
if the residual is above the preselected sensor fault threshold, generating a second model for the measured data points.

10. The method of claim 9, wherein the first and second models are generated utilizing a machine learning operation.

11. The method of claim 10, wherein the first and second models are linear or non-linear SVM regressions.

12. The method of claim 9, further comprising:
estimating anticipated data points for each of the measured data points utilizing the second model;
determining a second residual between a measured data point of the plurality of data points and a corresponding second anticipated data point; and
determining if the second residual is above the preselected sensor fault threshold.

13. The method of claim 12, wherein if the second residual is above the preselected sensor fault threshold:
removing the sensor from the wellbore.

14. The method of claim 9, further comprising:
determining if the second residual is above a second preselected sensor fault threshold; and
if the second residual is above the second preselected sensor fault threshold:
measuring a second plurality of data points of the modeling parameter with the sensor.

15. The method of claim 9, wherein if the second residual is above the preselected sensor fault threshold:
measuring a second plurality of data points of the modeling parameter with a backup sensor;
determining a third residual between a second measured data point of the second plurality of data points and a corresponding anticipated data point; and
determining if the third residual is above the preselected sensor fault threshold.

16. A method for determining sensor failure for a survey tool in a wellbore comprising:
measuring a plurality of data points of a modeling parameter with a sensor;
generating a model for the measured data points;
estimating anticipated data points for each of the measured data points;
determining a residual between a measured data point of the plurality of data points and a corresponding anticipated data point;
determining if the residual is above a preselected sensor fault threshold; and
if the residual is above the preselected sensor fault threshold, removing the sensor from the wellbore.

17. The method of claim 16, wherein the first and second models are generated utilizing a machine learning operation.
